(19) United States
(12) Patent Application Publication
(10) Pub. No.: US 2026/0237319 A1
(43) Pub. Date: Aug. 13, 2026

(54) Generating Customized Questionnaires Based on Emotion Index

(71) Applicant: International Business Machines Corporation, Armonk, NY (US)

(72) Inventors: Jian Jun Wang, Xi'an (CN); Di Xu, Shanghai (CN); Jing Lei Guo, Ningbo (CN); Wei Jun Zheng, Shanghai (CN); Yue Gao, Beijing (CN); Wen Ting Su, Beijing (CN)

(21) Appl. No.: 19/049,243

(22) Filed: Feb. 10, 2025

(51) Int. Cl. G09B 7/04

(52) U.S. Cl. CPC G09B 7/04

(57) ABSTRACT

Generating customized questionnaires for respective users is provided. A rank of a customized questionnaire corresponding to a user is determined based on an initial questionnaire difficulty level determined for the customized questionnaire and a current emotion index determined for the user. A number of questions to be included in the customized questionnaire along with a level of difficulty for the number of questions is determined based on the rank of the customized questionnaire corresponding to the user. The customized questionnaire corresponding to the user is generated utilizing the number of questions having the level of difficulty selected from a questionnaire database based on the rank of the customized questionnaire.

### BACKGROUND

The disclosure relates generally to questionnaires and more specifically to questionnaire management.

Typically, a questionnaire is a research instrument with a series of standardized questions designed to collect statistically useful information from respondents. A questionnaire can be used to conduct a survey on a specific topic, issue, product, service, or the like. Questionnaires are widely used in academic research, marketing research, quantitative research, and the like to gather information from individuals regarding their thoughts, preferences, behaviors, and experiences. Questionnaires generally have a structured format ensuring that each respondent answers the same set of questions.

### SUMMARY

According to one illustrative embodiment, a computer-implemented method is provided. A computer determines a rank of a customized questionnaire corresponding to a user based on an initial questionnaire difficulty level determined for the customized questionnaire and a current emotion index determined for the user. The computer determines a number of questions to be included in the customized questionnaire along with a level of difficulty for the number of questions based on the rank of the customized questionnaire corresponding to the user. The computer generates the customized questionnaire corresponding to the user utilizing the number of questions having the level of difficulty selected from a questionnaire database based on the rank of the customized questionnaire. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of a questionnaire management system in accordance with an illustrative embodiment; and

FIGS. 3A-3B are a flowchart illustrating a process for generating individually customized questionnaires for respective users in accordance with an illustrative embodiment.

### DETAILED DESCRIPTION

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

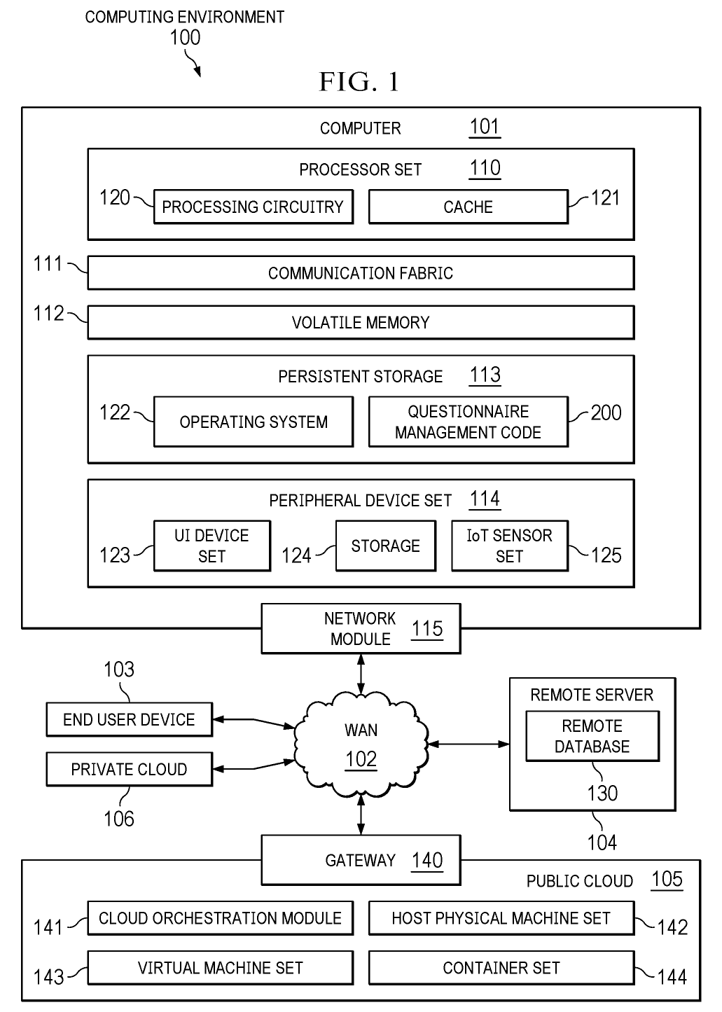

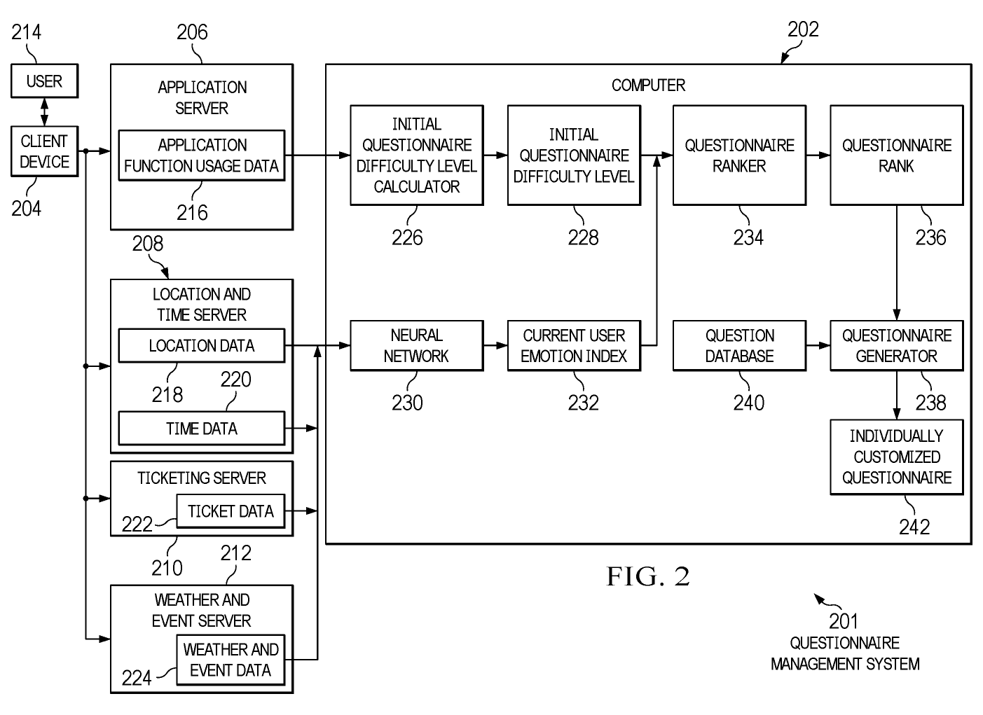

With reference now to the figures, and in particular, with reference to FIGS. 1 and 2, diagrams of data processing environments are provided in which illustrative embodiments may be implemented. It should be appreciated that FIGS. 1 and 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as questionnaire management code 200.

For example, questionnaire management code 200 generates individually customized questionnaires for respective users using different numbers of questions having different levels of difficulty depending on each respective user. Questionnaire management code 200 determines the average difficulty level of questions and the number of questions in a customized questionnaire for a particular user based on the rank of the customized questionnaire. Questionnaire management code 200 determines the customized questionnaire rank based on determining an initial questionnaire difficulty level and user emotion index corresponding to that particular user.

Questionnaire management code 200 determines the initial difficulty level of the customized questionnaire based on historical application function usage data (e.g., application function access frequency) corresponding to the user that questionnaire management code 200 retrieved from application server usage records. Questionnaire management code 200 determines the user emotion index of the user using a neural network. Questionnaire management code 200 trains the neural network based on a plurality of different training data. The training data input into the neural network may include, for example, data regarding local events, weather, and the like collected from public websites based on the current geographic location of the user. The training data may also include data regarding time of day and day of week indicating whether the user may be hungry, which questionnaire management code 200 may identify by analyzing online research papers, based on the current local time corresponding to the current geographic location of the user. In addition, the training data may further include data regarding level of satisfaction or dissatisfaction of the user with a function of the application collected from a ticketing system corresponding to an entity providing the application. The entity may be, for example, an enterprise, business, company, organization, institution, agency, individual, or the like.

Questionnaire management code 200 trains the neural network based on the training data using forward propagation, loss computation, backpropagation, and gradient descent. For example, questionnaire management code 200 trains the neural network based on the training data using backpropagation that includes gradient descent (e.g., Stochastic, batch, mini-batch, momentum-based, or the like) to decrease a loss function or objective function by adjusting weights and biases of the neural network to increase accuracy of the neural network.

Questionnaire management code 200 determines the questionnaire rank based on the determined initial questionnaire difficulty level and the determined user emotion index corresponding to the user. Questionnaire management code 200 generates the individually customized questionnaire for the user by selecting from a question database a determined number of questions having a determined level of difficulty based on the determined questionnaire rank of the individually customized questionnaire corresponding to the user. Questionnaire management code 200 sends the individually customized questionnaire to the user for completion. Upon receiving the completed questionnaire from the user, questionnaire management code 200 analyzes the answers and generates a summary.

In addition to questionnaire management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and questionnaire management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in questionnaire management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source portable operating system interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a customer of an entity that utilizes the customized questionnaire generation services provided by computer 101), and may take any of the forms discussed above in connection with computer 101. EUD 103 typically receives helpful and useful data from the operations of computer 101. For example, in a hypothetical case where computer 101 is designed to provide an individually customized questionnaire to the end user, this individually customized questionnaire would typically be communicated from network module 115 of computer 101 through WAN 102 to EUD 103. In this way, EUD 103 can display, or otherwise present, the individually customized questionnaire to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide individually customized questionnaires to respective users based partially on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A, one of item B, and ten of item C, or four of item B and seven of item C, or other suitable combinations.

In the digital world, questionnaires are often utilized to collect user feedback. For example, after an event, event participants are asked to provide feedback via a questionnaire regarding event performance. Similarly, after a webpage user remains on a particular webpage for a certain amount of time, a questionnaire may pop up asking the user for feedback regarding the webpage. The same may be true for applications as well.

Typically, users are asked to provide feedback via a questionnaire containing the same rigid and uniform questions. For example, current questionnaires require a group of users to answer a multitude of the same questions, which may lead to users quickly filling in answers to these same questions or rejecting the questionnaires altogether. Usually, users are not willing to take the time to provide real and useful information through these rigid and uniform questionnaires leading to low quality user feedback. However, if a questionnaire is dynamically customized according to current and historical data corresponding to a user, the user may be more willing to provide high quality feedback. Thus, a user feedback collection process via individually customized questionnaires can be more effective, more efficient, and more user-friendly.

Illustrative embodiments collect historical application function usage data (e.g., access frequency of each function of a set of functions provided by an application) corresponding to a particular user from an application server hosting the application. Generally, this type of data is used to estimate the importance of each application function. However, illustrative embodiments use this type of data to determine the initial questionnaire difficulty level based on how often that particular user accesses a given function of the application. For example, illustrative embodiments determine the initial questionnaire difficulty level utilizing the equation: Initial questionnaire difficulty level = Sum(function weight * user access frequency percent) / difficulty level step.

Weights of application functions are predefined by a privileged user, such as a system administrator, or suggested by, for example, a large language model or the like. Applications functions may include, for example, user login, view account, perform a transaction, generate an order, or the like. Illustrative embodiments utilize the function weight to evaluate the value of a particular function of the application. User access frequency percent = the user access count of a particular function / the total user access count of the application. The difficulty level step corresponds to predefined difficulty levels of a customized questionnaire. For example, a level 1 difficulty level is below value 20, a level 2 difficulty level is values 20-40, and a level 3 difficulty level is values 40-60. Thus, in this example, the difficulty level step between levels is 20.

Further, knowing a user’s current geographic location, illustrative embodiments can determine the local weather of where the user is located and also determine whether any local events are occurring at that location. It should be noted that research indicates that certain weather and events can positively or negatively affect the emotional state of a user. Furthermore, by taking time into account, illustrative embodiments can predict the blood sugar level of the user and determine whether the user will tend to be hungry, angry, negative, or the like at that point in time. It should be noted that research also indicates that too high or too low blood sugar levels can affect the emotional state and decision making ability of the user. As a result, illustrative embodiments can determine whether the user is more or less likely to complete a questionnaire based on time of day and current location of the user.

Illustrative embodiments utilize a neural network (e.g., a transformer neural network or the like) to determine the user emotion index corresponding to each particular user. Illustrative embodiments train the neural network based on inputting certain training data. The training data input into the neural network may include, for example: identified local event (e.g., forest fire) provided by public news plus number of hours since the local event occurred until now (i.e., the current time corresponding to the user); identified inclement weather pattern (e.g., severe thunderstorm) provided by public news or weather website plus number of hours since the inclement weather pattern occurred until now; identified day of week and time of day provided by an electronic calendar; predicted level of user hunger based on blood sugar level research statistics; and identified emotional state of the user based on extracting information from a problem ticketing system corresponding to the application. For example, the user may have submitted several complaints to the problem ticketing system indicating that one or more functions of the application are not user-friendly (e.g., not easy to use).

The trained neural network determines the user emotion index using the data above. In addition, the trained neural network can determine the user emotion index by also utilizing scores of previous questionnaires taken by the user. For example, if the user rejected a previous questionnaire, then the trained neural network calculates a negative questionnaire score for that particular questionnaire. If the user took a reasonable amount of time (e.g., within a defined time range) to complete the previous questionnaire, then the trained neural network calculates a questionnaire score of 100 for that particular questionnaire. If the user took too short a period of time or too long a period of time (e.g., either below or above the defined time range) to complete the previous questionnaire, then the trained neural network calculates that the questionnaire score is equal to (|time duration| / reasonable amount of time) multiplied by 100. Afterward, the trained neural network may calculate the user emotion index equal to the previous questionnaire score divided by 100.

Illustrative embodiments determine the rank of the questionnaire based on the determined initial questionnaire difficulty level and determined user emotion index. If illustrative embodiments determine that the user emotion index corresponding to the user is less than a defined minimum emotion index threshold value, then illustrative embodiments cancel generating the customized questionnaire for the user because illustrative embodiments determined that the user is not currently in an emotional state conducive to the user completing the questionnaire or providing quality answers. Conversely, if illustrative embodiments determine that the user emotion index corresponding to the user is greater than or equal to the defined minimum emotion index threshold value, then illustrative embodiments determine the rank of the questionnaire by multiplying the initial questionnaire difficulty level by the user emotion index. A privileged user, such as a system administrator who can change system configuration settings, may set the defined minimum emotion index threshold value based on privileged user preference. For example, the privileged user may set the defined minimum emotion index threshold value as an average of user emotion index values of all canceled questionnaires of users or the lower percentile (e.g., 25%) of user emotion index values of all non-canceled questionnaires of users.

Illustrative embodiments utilize a question database containing all the candidate questions generated for a specific entity or application system. Each candidate question includes at least the following three attributes: 1) question difficulty level; 2) corresponding application function; and 3) answer count for that particular question. The answer count indicates the number of answers needed for a particular question. For example, one question may need only one answer while another question may need multiple answers. A questionnaire generator of illustrative embodiments utilizes at least these three question attributes while selecting questions for an individually customized questionnaire for a particular user.

The questionnaire generator generates the individually customized questionnaire for that particular user using a set of candidate questions in the question database for the specified application function based on the questionnaire rank that illustrative embodiments determined. Illustrative embodiments include an increased number of questions having a higher level of difficulty in a customized questionnaire based on a higher determined questionnaire rank for the individually customized questionnaire to be generated for that particular user. In other words, the questionnaire rank determines the average level of difficulty of questions and the total number of questions that are included in the individually customized questionnaire for that particular user.

Illustrative embodiments send the individually customized questionnaire to that particular user for completion. Because the individually customized questionnaire is tailored specifically for that particular user, the user may feel comfortable with the questions and may be willing to finish the customized questionnaire with higher quality answers to the questions. For example, illustrative embodiments may have predicted that the user will be in a good mental state or mood when taking the customized questionnaire and that the user knows the subject matter corresponding to the customized questionnaire well. As a result, the user may be willing to take more time to provide quality answers to all of the questions in the individually customized questionnaire. Upon completing the customized questionnaire, the user sends the completed customized questionnaire back to illustrative embodiments for analysis and summarization.

It should be noted that illustrative embodiments can generate customized questionnaires that can be used by a multitude of different types of entities to collect useful user feedback and statistics. For example, by focusing customized questionnaires on how individual customers respond to different features of different products, illustrative embodiments can help manufacturers determine how to improve product features and customer experiences.

Thus, illustrative embodiments provide one or more technical solutions that overcome a technical problem with providing generic questionnaires with the same number and type of questions to a group of users resulting in lower quality user feedback. As a result, these one or more technical solutions provide a technical effect and practical application in the field of questionnaires by obtaining higher quality user feedback based on the current user emotion index predicted by a trained neural network using current user data.

With reference now to FIG. 2, a diagram illustrating an example of a questionnaire management system is depicted in accordance with an illustrative embodiment. Questionnaire management system 201 may be implemented in a computing environment, such as computing environment 100 in FIG. 1. Questionnaire management system 201 is a system of hardware and software components for generating customized questionnaires for respective users based on determining an initial questionnaire difficulty level and user emotion index for each respective user.

In this example, questionnaire management system 201 includes computer 202, client device 204, application server 206, location and time server 208, ticketing server 210, and weather and event server 212. Computer 202 may be, for example, computer 101 in FIG. 1. Client device 204 may be, for example, EUD 103 in FIG. 1. Application server 206, location and time server 208, ticketing server 210, and weather and event server 212 may be, for example, host physical machines of a public cloud, such as host physical machine set 142 of public cloud 105. However, it should be noted that questionnaire management system 201 is intended as an example only and not as a limitation on illustrative embodiments. For example, questionnaire management system 201 may include any number of computers, client devices, servers, and other devices and components not shown.

In this example, computer 202 includes initial questionnaire difficulty level calculator 226, neural network 230, questionnaire ranker 234, questionnaire generator 238, and question database 240. However, it should be noted that computer 202 may include more or fewer components than shown. For example, one or more components may be combined into one component, one component may be divided into two or more components, or a component not shown may be added. Further, it should be noted that initial questionnaire difficulty level calculator 226, neural network 230, questionnaire ranker 234, and questionnaire generator 238 may be implemented by questionnaire management code 200 in FIG. 1. In addition, question database 240 may be located remotely on a different computer instead of locally as shown.

Computer 202 receives an input to generate an individually customized questionnaire for user 214 to take regarding a function of an application provided by an entity. The input may be received automatically from the application, itself, the entity, or the like. In response to receiving the input, computer 202 collects information associated with user 214 from at least one of application server 206, location and time server 208, ticketing server 210, and weather and event server 212. The collected information includes, for example, application function usage data 216, location data 218, time data 220, ticket data 222, and weather and event data 224.

Application function usage data 216 represent historical information as to the frequency or how many times user 214 previously accessed the function of the application hosted by application server 206. Location data 218 represent the current geographic location of user 214 when computer 202 received the input to generate the individually customized questionnaire for user 214.

Time data 220 represent the current local time corresponding to the current geographic location of user 214. Time data 220 may also include day of the week information in addition to the current local time if different from the day of the week corresponding to the geographic location of computer 202. In addition, it should be noted that time data 220 may be collected directly from client device 204 in addition to, or instead of, location and time server 208.

Ticket data 222 represent information extracted from a problem ticket submitted by user 214 to ticketing server 210 indicating, for example, the current emotional state or level of dissatisfaction of user 214 with the function of the application provided by the entity. Weather and event data 224 represent information regarding the current weather conditions associated with the current geographic location of user 214 and information regarding any current events occurring in the current geographic location of user 214. Also, it should be noted that computer 202 may collect weather and event data 224 from local news feeds associated with the current geographic location of user 214 in addition to, or instead of, weather and event server 212.

Upon collecting the information, computer 202 inputs application function usage data 216 into initial questionnaire difficulty level calculator 226. Initial questionnaire difficulty level calculator 226 determines initial questionnaire difficulty level 228 for the individually customized questionnaire for user 214 based on analyzing application function usage data 216. For example, initial questionnaire difficulty level calculator 226 may detect that user 214 has frequently accessed a particular function of the application hosted by application server 206 (e.g., more than a defined application function access threshold level) over a certain period of time. As a result, initial questionnaire difficulty level calculator 226 may determine that user 214 has a higher than average knowledge of and is familiar with the application hosted by application server 206. Consequently, initial questionnaire difficulty level calculator 226 may set initial questionnaire difficulty level 228 higher for an individually customized questionnaire corresponding to user 214 as opposed to another user that has only accessed that particular function of the application hosted by application server 206 once or twice.

Further, computer 202 inputs location data 218, time data 220, ticket data 222, and weather and event data 224 corresponding to user 214 into neural network 230. Neural network 230 determines current user emotion index 232 for user 214 based on analyzing location data 218, time data 220, ticket data 222, and weather and event data 224 corresponding to user 214. Current user emotion index 232 indicates the current emotional state of user 214 in relation to the current level of interest or inclination of user 214 in taking and completing a questionnaire with quality responses based on research studies regarding, for example, the effects that time of day, blood sugar levels, inclement weather, tragic events, and the like have on the emotional and physical state of individuals.

Computer 202 then inputs initial questionnaire difficulty level 228 and current user emotion index 232 corresponding to user 214 into questionnaire ranker 234. First, questionnaire ranker 234 compares current user emotion index 232 corresponding to user 214 to a defined minimum emotion index threshold level. If questionnaire ranker 234 determines that current user emotion index 232 corresponding to user 214 is less than the defined minimum emotion index threshold level based on the comparison, then questionnaire ranker 234 cancels generation of the individually customized questionnaire for user 214. Otherwise, if questionnaire ranker 234 determines that current user emotion index 232 corresponding to user 214 is greater than or equal to the defined minimum emotion index threshold level, then questionnaire ranker 234 determines questionnaire rank 236 of the individually customized questionnaire to be generated for user 214 based on initial questionnaire difficulty level 228 and current user emotion index 232 corresponding to user 214.

Computer 202 then inputs questionnaire rank 236 into questionnaire generator 238. Based on questionnaire rank 236, questionnaire generator 238 determines the number and difficulty level of questions to be included in the individually customized questionnaire to be generated for user 214. Afterward, questionnaire generator 238 selects the determined number of questions having the determined level of difficulty from question database 240. In response to selecting the appropriate number of questions with the appropriate level of difficulty from question database 240 based on questionnaire rank 236, questionnaire generator 238 generates individually customized questionnaire 242 for user 214.

Computer 202 sends individually customized questionnaire 242 to client device 204 for user 214 to complete. User 214 completes individually customized questionnaire 242 by providing answers to the questions. Subsequently, user 214 sends the completed questionnaire back to computer 202 for analysis and summarization.

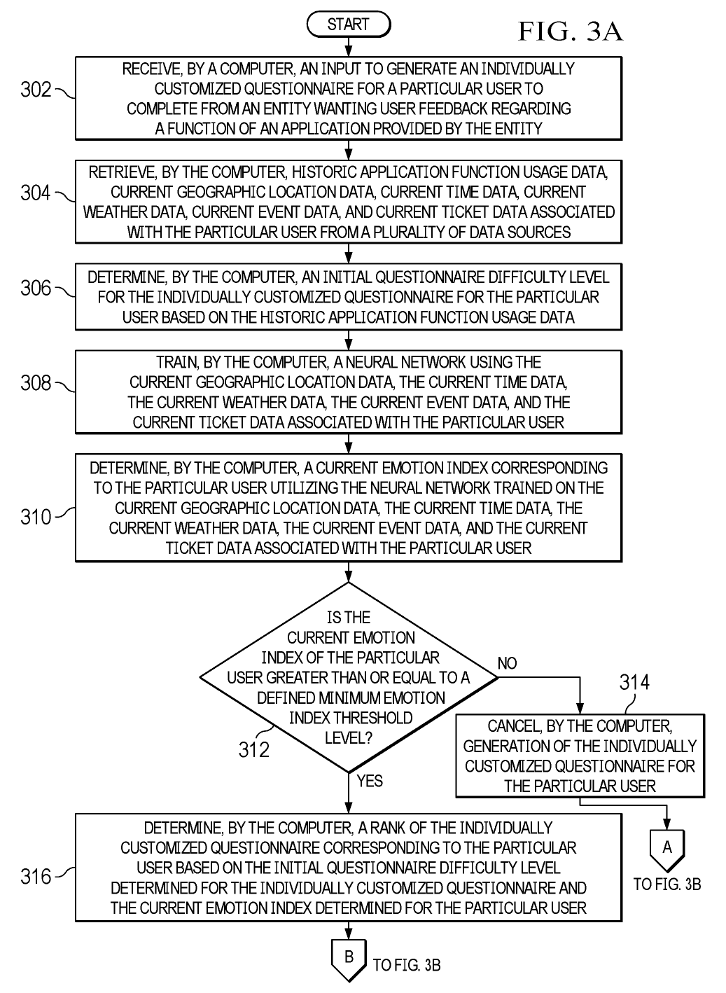

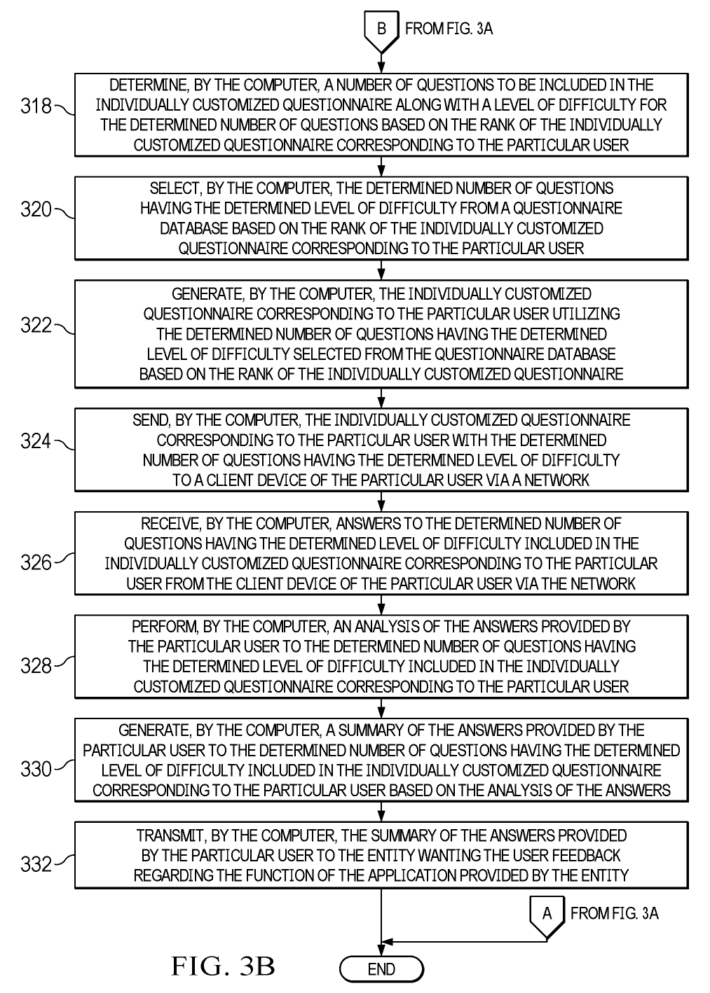

With reference now to FIGS. 3A-3B, a flowchart illustrating a process for generating individually customized questionnaires for respective users is shown in accordance with an illustrative embodiment. The process shown in FIGS. 3A-3B may be implemented in a computer, such as, for example, computer 101 in FIG. 1 or computer 202 in FIG. 2. For example, the process shown in FIGS. 3A-3B may be implemented by questionnaire management code 200 in FIG. 1.

The process begins when the computer receives an input to generate an individually customized questionnaire for a particular user to complete from an entity wanting user feedback regarding a function of an application provided by the entity (step 302). In response to the computer receiving the input to generate the individually customized questionnaire for the particular user, the computer retrieves historic application function usage data, current geographic location data, current time data, current weather data, current event data, and current ticket data associated with the particular user from a plurality of data sources (step 304).

The computer determines an initial questionnaire difficulty level for the individually customized questionnaire for the particular user based on the historic application function usage data (step 306). In addition, the computer trains a neural network using the current geographic location data, the current time data, the current weather data, the current event data, and the current ticket data associated with the particular user (step 308). The computer determines a current emotion index corresponding to the particular user utilizing the neural network trained on the current geographic location data, the current time data, the current weather data, the current event data, and the current ticket data associated with the particular user (step 310).

The computer makes a determination as to whether the current emotion index of the particular user is greater than or equal to a defined minimum emotion index threshold level (step 312). If the computer determines that the current emotion index of the particular user is not greater than or equal to the defined minimum emotion index threshold level, no output of step 312, then the computer cancels generation of the individually customized questionnaire for the particular user (step 314). Thereafter, the process terminates. If the computer determines that the current emotion index of the particular user is greater than or equal to the defined minimum emotion index threshold level, yes output of step 312, then the computer determines a rank of the individually customized questionnaire corresponding to the particular user based on the initial questionnaire difficulty level determined for the individually customized questionnaire and the current emotion index determined for the particular user (step 316).

Further, the computer determines a number of questions to be included in the individually customized questionnaire along with a level of difficulty for the determined number of questions based on the rank of the individually customized questionnaire corresponding to the user (step 318). The computer selects the determined number of questions having the determined level of difficulty from a questionnaire database based on the rank of the individually customized questionnaire corresponding to the particular user (step 320).

The computer generates the individually customized questionnaire corresponding to the particular user utilizing the determined number of questions having the determined level of difficulty selected from the questionnaire database based on the rank of the individually customized questionnaire (step 322). The computer sends the individually customized questionnaire corresponding to the particular user with the determined number of questions having the determined level of difficulty to a client device of the particular user via a network (step 324).

Subsequently, the computer receives answers to the determined number of questions having the determined level of difficulty included in the individually customized questionnaire corresponding to the particular user from the client device of the particular user via the network (step 326). The computer performs an analysis of the answers provided by the particular user to the determined number of questions having the determined level of difficulty included in the individually customized questionnaire corresponding to the particular user (step 328).

The computer generates a summary of the answers provided by the particular user to the determined number of questions having the determined level of difficulty included in the individually customized questionnaire corresponding to the particular user based on the analysis of the answers (step 330). The computer transmits the summary of the answers provided by the particular user to the entity wanting the user feedback regarding the function of the application provided by the entity (step 332). Thereafter, the process terminates.

Thus, illustrative embodiments of the present disclosure provide a computer-implemented method, computer system, and computer program product for generating individually customized questionnaires for respective users based on current emotion index of each respective user and initial questionnaire difficulty level. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining, by a computer, a rank of a customized questionnaire corresponding to a user based on an initial questionnaire difficulty level determined for the customized questionnaire and a current emotion index determined for the user;
determining, by the computer, a number of questions to be included in the customized questionnaire along with a level of difficulty for the number of questions based on the rank of the customized questionnaire corresponding to the user; and
generating, by the computer, the customized questionnaire corresponding to the user utilizing the number of questions having the level of difficulty selected from a questionnaire database based on the rank of the customized questionnaire.

2. The computer-implemented method of claim 1, further comprising:
sending, by the computer, the customized questionnaire corresponding to the user with the number of questions having the level of difficulty to a client device of the user via a network;
receiving, by the computer, answers to the number of questions having the level of difficulty included in the customized questionnaire corresponding to the user from the client device of the user via the network; and
performing, by the computer, an analysis of the answers provided by the user to the number of questions having the level of difficulty included in the customized questionnaire corresponding to the user.

3. The computer-implemented method of claim 1, further comprising:
generating, by the computer, a summary of answers provided by the user to the number of questions having the level of difficulty included in the customized questionnaire corresponding to the user based on an analysis of the answers; and
transmitting, by the computer, the summary of the answers provided by the user to an entity wanting user feedback regarding a function of an application provided by the entity.

4. The computer-implemented method of claim 1, further comprising:
receiving, by the computer, an input to generate the customized questionnaire for the user from an entity wanting user feedback regarding a function of an application provided by the entity;
retrieving, by the computer, historic application function usage data, current geographic location data, current time data, current weather data, current event data, and current ticket data associated with the user from a plurality of data sources in response to the computer receiving the input to generate the customized questionnaire for the user; and
determining, by the computer, the initial questionnaire difficulty level for the customized questionnaire for the user based on the historic application function usage data.

5. The computer-implemented method of claim 1, further comprising:
training, by the computer, a neural network using current geographic location data, current time data, current weather data, current event data, and current ticket data associated with the user; and
determining, by the computer, the current emotion index corresponding to the user utilizing the neural network trained on the current geographic location data, the current time data, the current weather data, the current event data, and the current ticket data associated with the user.

6. The computer-implemented method of claim 1, further comprising:
determining, by the computer, whether the current emotion index of the user is greater than a defined minimum emotion index threshold level; and
responsive to the computer determining that the current emotion index of the user is greater than the defined minimum emotion index threshold level, determining, by the computer, the rank of the customized questionnaire corresponding to the user.

7. The computer-implemented method of claim 6, further comprising:
responsive to the computer determining that the current emotion index of the user is not greater than the defined minimum emotion index threshold level, canceling, by the computer, generation of the customized questionnaire for the user.

8. A computer system comprising:
a processor set;
one or more computer-readable storage media; and
program instructions stored on the one or more computer-readable storage media to cause the processor set to perform operations comprising:
determining a rank of a customized questionnaire corresponding to a user based on an initial questionnaire difficulty level determined for the customized questionnaire and a current emotion index determined for the user;
determining a number of questions to be included in the customized questionnaire along with a level of difficulty for the number of questions based on the rank of the customized questionnaire corresponding to the user; and
generating the customized questionnaire corresponding to the user utilizing the number of questions having the level of difficulty selected from a questionnaire database based on the rank of the customized questionnaire.

9. The computer system of claim 8, wherein the operations further comprise:
sending the customized questionnaire corresponding to the user with the number of questions having the level of difficulty to a client device of the user via a network;
receiving answers to the number of questions having the level of difficulty included in the customized questionnaire corresponding to the user from the client device of the user via the network; and
performing an analysis of the answers provided by the user to the number of questions having the level of difficulty included in the customized questionnaire corresponding to the user.

10. The computer system of claim 8, wherein the operations further comprise:
generating a summary of answers provided by the user to the number of questions having the level of difficulty included in the customized questionnaire corresponding to the user based on an analysis of the answers; and
transmitting the summary of the answers provided by the user to an entity wanting user feedback regarding a function of an application provided by the entity.

11. The computer system of claim 8, wherein the operations further comprise:
receiving an input to generate the customized questionnaire for the user from an entity wanting user feedback regarding a function of an application provided by the entity;
retrieving historic application function usage data, current geographic location data, current time data, current weather data, current event data, and current ticket data associated with the user from a plurality of data sources in response to receiving the input to generate the customized questionnaire for the user; and
determining the initial questionnaire difficulty level for the customized questionnaire for the user based on the historic application function usage data.

12. The computer system of claim 8, wherein the operations further comprise:
training a neural network using current geographic location data, current time data, current weather data, current event data, and current ticket data associated with the user; and
determining the current emotion index corresponding to the user utilizing the neural network trained on the current geographic location data, the current time data, the current weather data, the current event data, and the current ticket data associated with the user.

13. The computer system of claim 8, wherein the operations further comprise:
determining whether the current emotion index of the user is greater than a defined minimum emotion index threshold level; and
responsive to determining that the current emotion index of the user is greater than the defined minimum emotion index threshold level, determining the rank of the customized questionnaire corresponding to the user.

14. A computer program product comprising:
one or more computer-readable storage media; and
program instructions stored on the one or more computer-readable storage media to perform operations comprising:
determining, by a computer, a rank of a customized questionnaire corresponding to a user based on an initial questionnaire difficulty level determined for the customized questionnaire and a current emotion index determined for the user;
determining, by the computer, a number of questions to be included in the customized questionnaire along with a level of difficulty for the number of questions based on the rank of the customized questionnaire corresponding to the user; and
generating, by the computer, the customized questionnaire corresponding to the user utilizing the number of questions having the level of difficulty selected from a questionnaire database based on the rank of the customized questionnaire.

15. The computer program product of claim 14, wherein the operations further comprise:
sending, by the computer, the customized questionnaire corresponding to the user with the number of questions having the level of difficulty to a client device of the user via a network;
receiving, by the computer, answers to the number of questions having the level of difficulty included in the customized questionnaire corresponding to the user from the client device of the user via the network; and
performing, by the computer, an analysis of the answers provided by the user to the number of questions having the level of difficulty included in the customized questionnaire corresponding to the user.

16. The computer program product of claim 14, wherein the operations further comprise:
generating, by the computer, a summary of answers provided by the user to the number of questions having the level of difficulty included in the customized questionnaire corresponding to the user based on an analysis of the answers; and
transmitting, by the computer, the summary of the answers provided by the user to an entity wanting user feedback regarding a function of an application provided by the entity.

17. The computer program product of claim 14, wherein the operations further comprise:
receiving, by the computer, an input to generate the customized questionnaire for the user from an entity wanting user feedback regarding a function of an application provided by the entity;
retrieving, by the computer, historic application function usage data, current geographic location data, current time data, current weather data, current event data, and current ticket data associated with the user from a plurality of data sources in response to the computer receiving the input to generate the customized questionnaire for the user; and
determining, by the computer, the initial questionnaire difficulty level for the customized questionnaire for the user based on the historic application function usage data.

18. The computer program product of claim 14, wherein the operations further comprise:
training, by the computer, a neural network using current geographic location data, current time data, current weather data, current event data, and current ticket data associated with the user; and
determining, by the computer, the current emotion index corresponding to the user utilizing the neural network trained on the current geographic location data, the current time data, the current weather data, the current event data, and the current ticket data associated with the user.

19. The computer program product of claim 14, wherein the operations further comprise:
determining, by the computer, whether the current emotion index of the user is greater than a defined minimum emotion index threshold level; and
responsive to the computer determining that the current emotion index of the user is greater than the defined minimum emotion index threshold level, determining, by the computer, the rank of the customized questionnaire corresponding to the user.

20. The computer program product of claim 19, wherein the operations further comprise:
responsive to the computer determining that the current emotion index of the user is not greater than the defined minimum emotion index threshold level, canceling, by the computer, generation of the customized questionnaire for the user.
